(19) United States
(12) Patent Application Publication
(10) Pub. No.: US 2011/0278858 A1
(43) Pub. Date: Nov. 17, 2011

(54) ENERGY PRODUCTION PLANT AND METHOD FOR OPERATING THE SAME

(76) Inventor: Gerald Hehenberger, Klagenfurt (AT)

(21) Appl. No.: 13/132,799

(22) PCT Filed: Dec. 3, 2009
(86) PCT No.: PCT/AT2009/000470

§ 371 Date: Jul. 19, 2011

(30) Foreign Application Priority Data
Dec. 3, 2008 (AT) A1878/2008

(51) Int. Cl. F03D 11/02

(52) U.S. Cl. 290/1 C

(57) ABSTRACT

An energy production plant, in particular a wind power plant, comprises a drive shaft, a generator (8), and a differential gear (11 to 13) having three inputs and/or outputs. A first input is connected to the drive shaft, an output is connected to a generator (8), and a second input is connected to a differential drive (6). Two generators (8, 16) are provided which have different pole pair numbers and can be connected to the output.

The invention relates to a power plant, in particular a wind power plant, with a drive shaft, a generator, and with a differential gear with three drives and power take-offs, whereby a first drive is connected to the drive shaft, a power take-off is connected to a generator, and a second drive is connected to a differential drive.

In addition, the invention relates to a method for operating a power plant, in particular a wind power plant, with three drives and power take-offs, whereby a first drive is connected to a drive shaft of the power plant, a power take-off is connected to a generator, and a second drive is connected to a differential drive.

Wind power plants are gaining increasing importance as electricity-producing plants. As a result, the proportion, in percent, of power produced by wind is continuously increasing. In turn, this produces, on the one hand, new standards relative to power quality and, on the other hand, a trend toward still larger wind power plants. At the same time, a trend toward off-shore wind power plants is discernible, which requires plant sizes of at least 5 MW of installed output. Here, both the degree of efficiency and also the availability of the plants gain special importance because of the high costs of the infrastructure and maintenance or servicing of the wind power plants in the offshore region.

A feature common to all plants is the need for a variable rotor speed, on the one hand to increase the aerodynamic efficiency in the partial load range and on the other hand to regulate the torque in the drive section of the wind power plant, the latter for the purpose of the speed regulation of the rotor in combination with the rotor blade adjustment.

For the most part, wind power plants are currently used that meet this requirement by using speed-variable generator solutions in the form of so-called doubly-fed three-phase a.c. machines or synchronous generators in combination with frequency converters. These solutions have the drawback, however, that (a) the electrical properties of the wind power plants in the case of a network disruption only conditionally meet the requirements of the electricity supply firm, (b) the wind power plants can only be connected by means of transformer stations to the mean voltage network, and (c) the frequency converters that are necessary for the variable speed are very powerful and are therefore a source of losses in efficiency.

These problems can be solved by the use of remotely activated mean-voltage synchronous generators. In this connection, however, alternative solutions are required to meet the requirement for variable rotor speeds or torque regulation in the drive train of the wind power plant. One option is the use of differential gears that allow a variable speed of the rotor of the wind power plant by changing the transmission ratio at constant generator speed.

### PRIOR ART

WO2004/109157 A1 shows a complex, hydrostatic “multipath” concept with several parallel differential stages and several switchable couplings, making it possible to switch among the individual paths. With the indicated technical solution, the output and thus the losses of the hydrostatics can be reduced. A significant drawback, however, is the complicated design of the overall unit. Moreover, the switching between the individual stages represents a problem in the regulation of the wind power plant. In addition, this publication shows a mechanical brake, which acts directly on the generator shaft.

WO 2006/010190 A1 shows a simple electrical design with a multi-stage differential gear, which preferably provides for an asynchronous generator as a differential drive. The nominal speed of the differential drive of 1,500 rpm is expanded by ⅓ to 2,000 rpm in the motor operation, which means a field-weakening range of approximately 33%.

EP 1283359 A1 shows a 1-stage and a multi-stage differential gear with an electric differential drive, whereby the 1-stage version has a special three-phase a.c. machine with high nominal speed that is positioned coaxially around the input shaft and that—as a function of the design—has an extremely high mass moment of inertia relative to the rotor shaft. As an alternative, a multi-stage differential gear with a high-speed standard three-phase a.c. machine is proposed, which is oriented parallel to the input shaft of the differential gear.

The drawbacks of known embodiments are, on the one hand, high losses in the differential drive or, on the other hand, in designs that solve this problem, complex mechanics or special electrical-machine technology, and thus high costs. In hydrostatic solutions, moreover, the service life of the pumps that are used is a problem, and a high expense in compliance with extreme environmental conditions is necessary. In general, it can be determined that the selected nominal speed ranges are either too small for the compensation of extreme loads or are too large for an optimum energy output of the wind power plant.

The object of the invention is to avoid the above-mentioned drawbacks as much as possible and to make available a differential drive, which, in addition to the lowest possible costs, ensures both maximum energy output and optimum regulation of the wind power plant.

This object is achieved with a power plant with the features of Claim 1 or 7 and with a method with the features of Claim 21 or 23.

Using the power plants according to the invention and the method for operating the latter according to the invention, the speed of the rotor of the power plants can be matched optimally to the available power supply, while it can be adapted to the wind speed in the case of wind power plants.

Preferred embodiments of the invention are the subjects of the subclaims.

Below, preferred embodiments of the invention are described in detail with reference to the drawings.

For a 5 MW wind power plant according to the prior art, FIG. 1 shows the output curve, the rotor speed, and the thus resulting characteristic values such as tip speed ratio and the output coefficient,

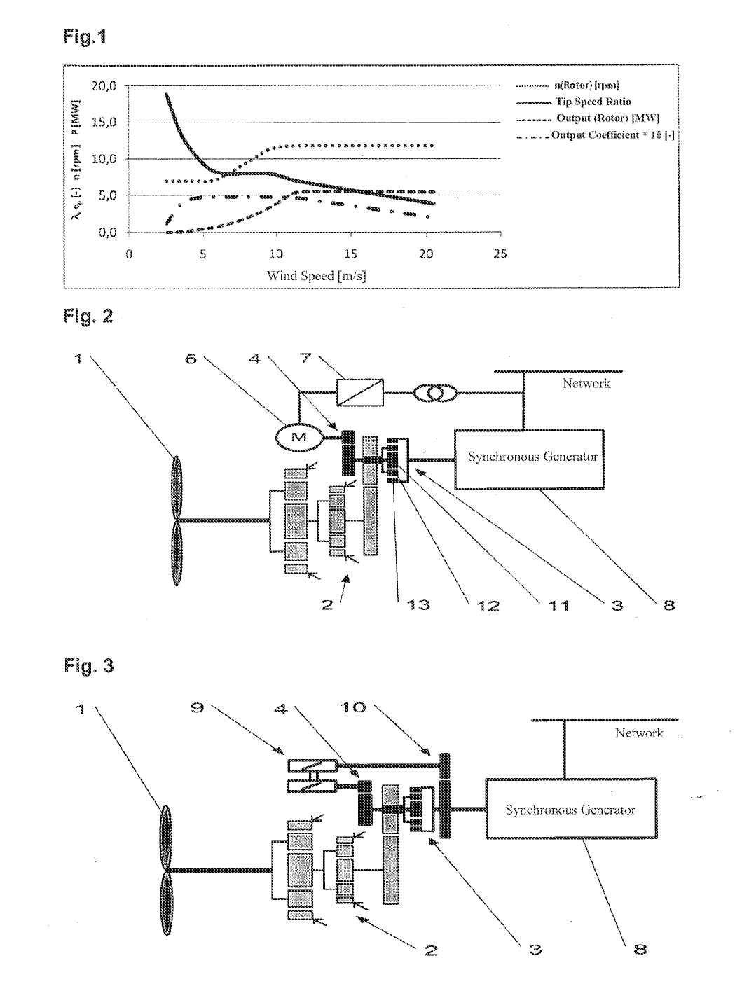

FIG. 2 shows the principle of a differential gear with an electric differential drive according to the prior art,

FIG. 3 shows the principle of a hydrostatic differential drive with a pump/motor combination according to the prior art,

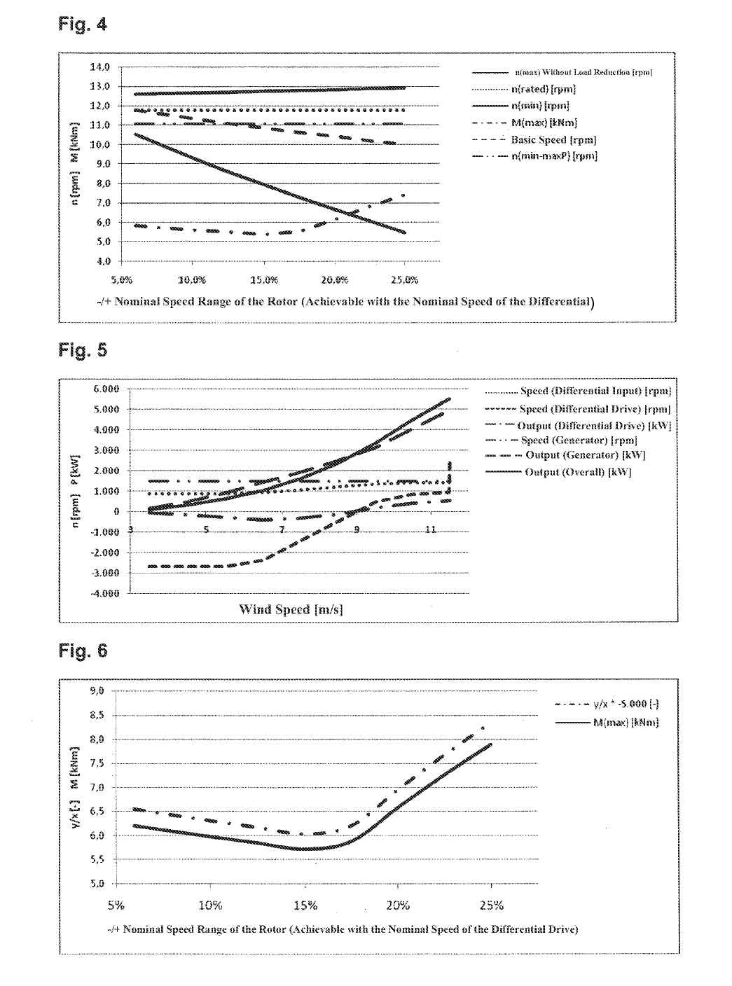

FIG. 4 shows the rotational-speed ratios on the rotor of the wind power plant and the thus resulting maximum input torque Mₘₐₓ for the differential drive,

By way of example, FIG. 5 shows the rotational-speed and output ratios of an electric differential drive over wind speed,

For the 1-stage differential gear, FIG. 6 shows the maximum torque and the size factor y/x as a function of the nominal speed range,

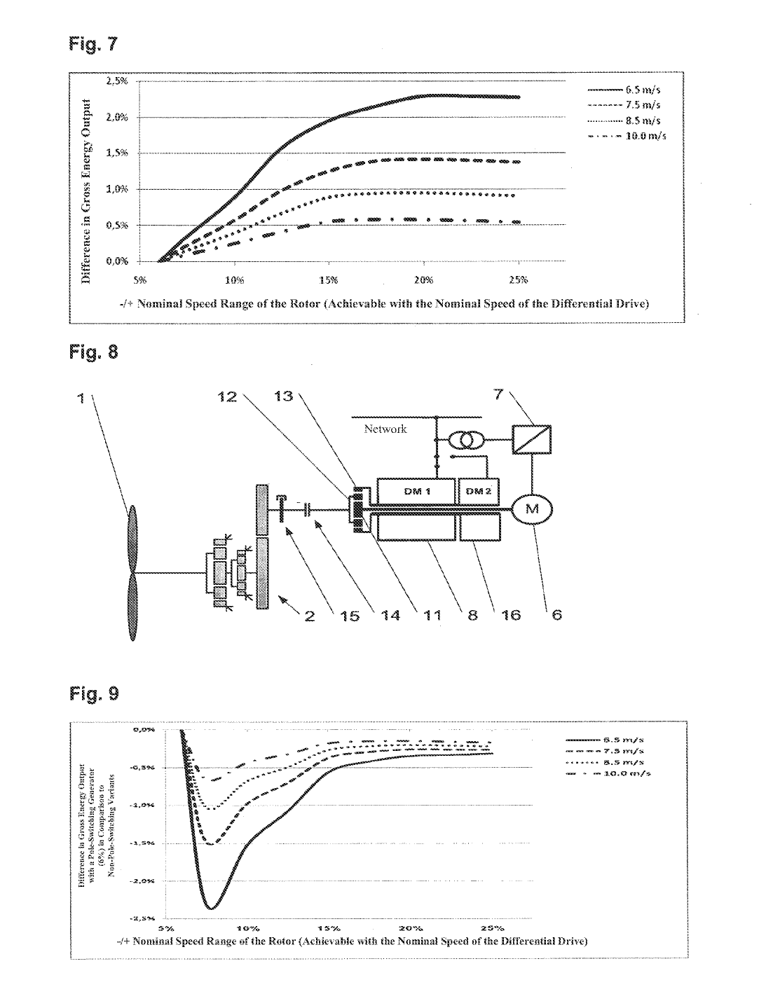

FIG. 7 shows the difference of the gross energy output for various nominal speed ranges at different mean annual wind speeds,

FIG. 8 shows a solution with two synchronous generators with various numbers of pole pairs,

FIG. 9 shows the difference of the gross energy output for an electric differential drive at various nominal speed ranges in comparison to a variant with a pole-switching generator (with −/+6% nominal speed range),

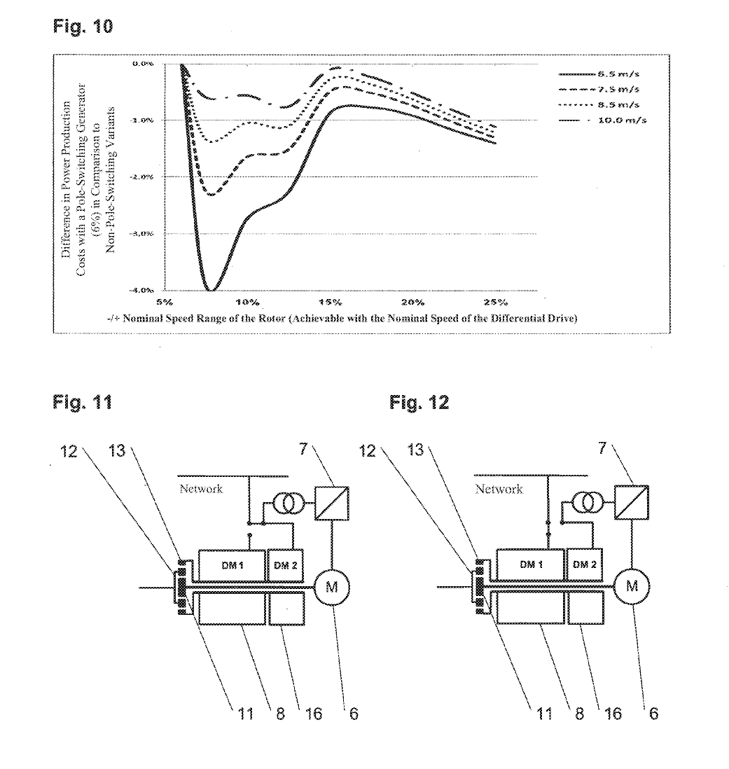

FIG. 10 shows the difference of the power production costs for an electric differential drive at various nominal speed ranges in comparison to a variant with a pole-switching generator (with −/+6% nominal speed range),

FIG. 11 shows a solution with two three-phase a.c. machines with a varying number of pole pairs and a frequency converter, which is connected to the network and the three-phase a.c. machine with the lower number of pole pairs,

FIG. 12 shows the solution of FIG. 11, whereby the frequency converter is connected to the three-phase a.c. machines with a higher number of pole pairs if the three-phase a.c. machine of the lower number of pole pairs is connected to the network.

The output of the rotor of a wind power plant is calculated from the formula

Rotor Output=Rotor Surface Area*Output Coefficient*Air Density/2*Wind Speed³,

whereby the output coefficient is based on the tip speed ratio (=ratio of blade tip speed to wind speed) of the rotor of the wind power plant. The rotor of a wind power plant is designed for an optimum output coefficient as a function of a tip speed ratio (in most cases a value of between 7 and 9) that is to be determined during development. For this reason, during operation of the wind power plant in the partial-load range, a correspondingly low speed is to be set to ensure optimum aerodynamic efficiency.

FIG. 1 shows the ratios for rotor output, rotor speed, tip speed ratio and output coefficient for a specified maximum speed range of the rotor or an optimum tip speed ratio of 8.0-8.5. It can be seen from the diagram that as soon as the tip speed ratio deviates from its optimum value of 8.0-8.5, the output coefficient drops, and the rotor output corresponding to the aerodynamic characteristic of the rotor is thus reduced according to the above-mentioned formula.

FIG. 2 shows a possible principle of a differential system that consists of differential stages 3 or 11 to 13, an adaptive reduction stage 4, and a differential drive 6. The rotor 1 of the wind power plant drives the main gearbox 2. The main gearbox 2 is a 3-stage gearbox with two planetary stages and a spur-wheel stage. Between the main gearbox 2 and the generator 8, there is the differential stage 3, which is driven by the main gearbox 2 via planetary carriers 12 of the differential stage 3. The generator 8—preferably a remotely activated synchronous generator, which if necessary can also have a nominal voltage of greater than 20 kV—is connected to the hollow wheel 13 of the differential stage 3 and is driven by the latter. The pinion gear 11 of the differential stage 3 is connected to the differential drive 6. The speed of the differential drive 6 is regulated, on the one hand to ensure, in the case of the variable speed of the rotor 1, a constant speed of the generator 8, and on the other hand to regulate the torque in the complete drive train of the wind power plant. In the case shown, to increase the input speed for the differential drive 6, a 2-stage differential gear is selected, which provides an adaptive reduction stage 4 in the form of a front-wheel stage between the differential stage 3 and the differential drive 6. The differential stage 3 and the adaptive reduction stage 4 thus form the 2-stage differential gear. The differential drive is a three-phase a.c. machine, which is connected to the network via a frequency converter 7 and a transformer 5. As an alternative, the differential drive, as shown in FIG. 3, can also be designed as, e.g., a hydrostatic pump/motor combination 9. In this case, the second pump is preferably connected via the adaptive reduction stage 10 to the drive shaft of the generator 8.

The equation of the speed for the differential gear reads:

Speed_{Generator}=x*Speed_{Rotor}+y*Speed_{Differential Drive}

whereby the generator speed is constant, and the factors x and y can be derived from the selected gear ratios of the main gearbox and the differential gear.

The torque on the rotor is determined by the available wind supply and the aerodynamic efficiency of the rotor. The ratio between the torque at the rotor shaft and that on the differential drive is constant, by which the torque in the drive train can be regulated by the differential drive. The equation of the torque for the differential drive reads:

TOrqUe_{Differential Drive}=Torque_{Rotor}*y/x,

whereby the size factor y/x is a measurement of the required design torque of the differential drive.

The output of the differential drive is essentially proportional to the product that consists of the percentage deviation of the rotor speed from its basic speed times rotor output (also called slip power). Consequently, a large speed range in principle requires a correspondingly large sizing of the differential drive.

FIG. 4 shows this by way of example for various speed ranges. The −/+nominal speed range of the rotor defines its percentage speed deviation from the basic speed of the rotor, which can be achieved without field weakening with the nominal speed of the differential drive (− . . . motor and + . . . generator). In the case of an electric three-phase a.c. machine, the nominal speed (n) of the differential drive defines any maximum speed in which the latter can permanently generate the nominal torque (Mₙ) or the nominal output (Pₙ).

In the case of a hydrostatic drive, such as, e.g., a hydraulic reciprocating piston pump, the nominal speed of the differential drive is any speed in which the latter with maximum torque (Tₘₐₓ) can yield maximum continuous output (P_{O max}). In this case, nominal pressure (p_{N}) and nominal size (NG) and displacement volumes (V_{g max}) of the pump determine the maximum torque (Tₘₐₓ).

In the nominal output range, the rotor of the wind power plant rotates at the mean speed n_{rated} between the limits nₘₐₓ and n_{maxP} in the partial-load range between n_{rated} and nₘᵢₙ, achievable in this example with a field-weakening range of 80%. The regulating speed range between nₘₐₓ and n_{min-maxP} which can be achieved without load reduction, is selected to be correspondingly large to be able to compensate for wind gusts. The size of this speed range depends on the gusting of the wind or the inertia of the rotor of the wind power plant and the dynamics of the so-called pitch system (rotor blade adjusting system) and is usually approximately −/+5%. In the example shown, a regulating speed range of −/+6% was selected to have corresponding reserves for the compensation of extreme gusts using differential drives. Wind power plants with very sluggish pitch systems can also be well designed, however, for regulating speed ranges of approximately −/+7% to −/+8%. In this regulating speed range, the wind power plant has to produce nominal output, which means that the differential drive in this case is loaded with maximum torque. This means that the −/+nominal speed range of the rotor has to be equally large, since only in this range can the differential drive achieve its nominal torque.

In the case of electric and hydrostatic differential drives with a differential stage, the rotor speed, in which the differential drive has the speed that is equal to 0, is named the basic speed. Since now in the case of small rotor speed ranges, the basic speed exceeds n_{min-maxP}, the differential drive has to be able to generate the nominal torque at a speed that is equal to 0. Differential drives, be they electric or else hydraulic, can only produce a torque, however, at a speed that is equal to 0, which is significantly below the nominal torque; this can be compensated for, however, by corresponding oversizing in the design. Since, however, the maximum design torque is the sizing factor for a differential drive, for this reason a smaller speed range has an only limited positive effect on the size of the differential drive.

In the case of a drive design with more than one differential stage, the −/+nominal speed range can be calculated in terms of replacement from the formula

−/+Nominal Speed Range=−/+(nₘₐₓ−nₘᵢₙ)/(nₘₐₓ+nₘᵢₙ)

for a basic speed=(nₘₐₓ+nₘᵢₙ)*0.5. The nominal speed of the differential drive in this case is determined in terms of replacement with its speeds at nₘₐₓ and respectively nₘᵢₙ.

In FIG. 5, by way of example, the rotational-speed or output ratios are provided for a differential stage. The speed of the generator, preferably a remotely activated mean voltage synchronous generator, is constant through the connection to the constant-frequency power network. To be able to use the differential drive correspondingly well, this drive is operated in motor mode in the lower range of the basic speed and in generator mode in the higher range of the basic speed. This means that the output in the differential stage is injected in the motor range and output from the differential stage is removed in the generator range. In the case of an electric differential drive, this output is preferably removed in the network or is fed into the latter. In the case of a hydraulic differential drive, the output is preferably removed in the generator shaft or is fed to the latter. The sum of the generator output and the differential drive output produces the overall output that is released into the network for an electric differential drive.

In addition to the torque on the differential input, the input torque for the differential drive also essentially depends on the transmission ratio of the differential gear. If the underlying analysis is that the optimum transmission ratio of a planetary stage is in a so-called stationary gear ratio of approximately 6, the torque for the differential drive, with a 1-stage differential gear, is not smaller proportionally to the speed range. Technically, even larger stationary gear ratios can be produced, which at best reduces this problem but does not eliminate it.

For a 1-stage differential gear, FIG. 6 shows the maximum torque and the size factor y/x (multiplied by −5,000 for display reasons) as a function of the nominal speed range of the rotor. In a nominal speed range of approximately −/+14% to −/+17%, the smallest size factor and consequently also the smallest maximum torque (Mₘₐₓ) are produced for the differential drive.

For a 1-stage differential gear, the lay-out shows that in the case of a nominal speed range that becomes smaller, the design torque for the differential drive grows. To solve this problem, e.g., a 2-stage differential gear can be used. This can be achieved, for example, by implementing an adaptive reduction stage 4 between the differential stage 3 and the differential drive 6 or 9. The input torque for the differential stage, which essentially determines the costs thereof, thus cannot be reduced, however.

The size of the differential drive also has, of course, a significant effect on the overall efficiency of the wind power plant. If the above-described embodiments are taken into consideration, the basic finding indicates that a larger speed range of the rotor of the wind power plant produces a better aerodynamic efficiency, but, on the other hand, it also requires a larger sizing of the differential drive. This in turn results in higher losses, which counteracts a better system efficiency (determined by the aerodynamics of the rotor and the losses of the differential drive).

FIG. 7 shows the difference of the gross energy output of the wind power plant with an electric differential drive in various mean annual wind speeds as a function of the nominal speed range of the rotor of the wind power plant. In this case, the gross energy output is based on the exhaust gas supply of the rotor of the wind power plant minus the losses of the differential drive (incl. the frequency converter) and the differential gear.

A nominal speed range of −1+6% is the basis, according to the invention, which is necessary by the minimum required regulation speed range in the nominal output range of wind power plants with differential drives, whereby the nominal speed range means any rotor-speed range that can be produced with nominal speed of the differential drive.

Moreover, a field-weakening range of up to 80% above the nominal speed of the differential drive is adopted.

From the layout, it is easy to detect that the optimum is achieved in a nominal speed range of approximately −/+20%, and a widening of the nominal speed range, moreover, is no longer advantageous.

FIG. 8 shows a solution according to the invention to achieve a high annual energy output with a small nominal speed range. The basis for this is the fact that three-phase a.c. machines with different numbers of pole pairs have different synchronous speeds. That is to say, a so-called 4-pole machine in the 50 Hz-network has a synchronous speed of 1,500 rpm, and a 6-pole machine has a synchronous speed of 1,000 rpm. This can be used by the wind power plant being operated at low wind speeds and consequently low outputs with 6-pole three-phase a.c. machines and at higher outputs with 4-pole three-phase a.c. machines. Preferably, remotely activated mean voltage synchronous generators are used.

In the possible variant embodiments shown, the rotor 1 drives the main gearbox 2, and the latter drives the differential stages 11 to 13 via the planetary carrier 12. The generator 8 is connected to the hollow wheel 13. The generator 8 is a 4-pole three-phase a.c. machine, and the generator 16 that sits on the same shaft is a 6-pole three-phase a.c. machine. The three-phase a.c. machines 8 and 16 can alternately in each case have separate shafts, which are connected to one another. Corresponding to the wind or output available, in the low wind/output range, the 6-pole three-phase a.c. machine 16, or, in the high wind/output range, the 4-pole three-phase a.c. machine 8 is connected to the network. The switchover point can vary corresponding to the prevailing wind conditions. Moreover, over-frequent switching between generator 8 and generator 16 can be prevented by means of so-called hysteresis.

Since the speed range that is now relevant for the energy output for the most part takes the two speeds of generators 8 and 16 into account, the differential drive only has to ensure the minimum regulating speed range of −/+6%.

To switch, e.g., from the generator 8 to the generator 16, the system output is preferably set to zero, then the generator 8 is separated from the network, subsequently the generator 16 is synchronized, and finally the output is run back up corresponding to the current wind supply. The generators 8 and 16 have a hollow shaft that makes it possible for the differential drive to be positioned on the side of the generators 8 and 16 that faces away from the differential gear. As a result, the differential stage is preferably connected to a separate assembly, linked to the generator 8, which then is preferably connected via a coupling 14 and a rotor brake 15 to the main gearbox 2.

Instead of two generators 8 and 16, a so-called pole-switching three-phase a.c. machine can also be used. In this embodiment, the stator is designed with two groups of windings of different numbers of pole pairs, between which it can be switched so that the machine is switchable, for example, between 6-pole and 4-pole. Usually, the windings in the pole-switching machines are made separately. By the separate design of the windings, the machine operates functionally like two separate machines as described above. In this respect, reference can be made structurally to the embodiments of FIGS. 3 and 4, from which the invention is in this case distinguished by the design of the generator 8 as a pole-switching machine with an electrically correspondingly altered switch.

Like FIG. 7, FIG. 9 shows the difference of the gross energy output of the wind power plant with an electric differential drive at various mean annual wind speeds based on the nominal speed range of the rotor of the wind power plant. In this example, however, the variant with the nominal speed range of −/+6% is designed with a 4/6-pole, pole-switching three-phase a.c. machine. Thus, this variant becomes the best option with respect to gross energy output.

Ultimately, it is the purpose to develop a drive train that allows the lowest power production costs.

The points relevant to this in the optimization of differential drives are (a) the gross energy output, (b) the production costs of the differential drive, and (c) the quality of the torque or speed regulation of the wind power plant that influences the overall production costs.

The gross energy output feeds proportionally into the power production costs and thus into the economic efficiency of a wind park. The production costs are in relation to the overall production costs of a so-called wind park, but only with the percentage of the proportional capital costs of the wind power plant to the overall costs of the wind park including maintenance and operating costs. On average, this wind power plant-specific proportion of the power production costs is approximately ⅔ in the so-called on-shore projects and is approximately ⅓ in off-shore projects. On average, therefore, a percentage of approximately 50% can be defined. This means that a difference in the annual energy output can be regarded as twice as high, on average, as the difference in the production costs of the wind power plant.

FIG. 10 shows the power production costs of a wind power plant with an electric differential drive at different nominal speed ranges in comparison to a variant with a pole-switching generator (with −/+6% nominal speed range). In this connection, an optimum can be clearly identified for the pole-switching variant.

For the above-described reasons of the optimal wind power plant regulation, the overall degree of efficiency, and the simple mechanical design of the differential gear that is at optimum cost, the pole-switching variant or, as an alternative, a variant with two generators with different numbers of pole pairs, represents a very good technical solution.

In the case of the variants with two generators with different numbers of pole pairs, there is another optimization option. The described variants of the differential drives with the electric differential drive have in common that in the generator operation of the differential drive, the so-called slip power is fed into the network via a frequency converter. To meet the power quality requirements, so-called IGBT converters plus corresponding filters are necessary for this reason.

FIGS. 11 and 12 show a variant embodiment with two three-phase a.c. machines with different numbers of pole pairs. In the low wind/output range, as FIG. 11 shows, the 6-pole three-phase a.c. machine 16 can be connected to the network, and the differential drive 6, e.g., can be operated only subsynchronously, whereby no output is fed into the network via the frequency converter 7, and the differential drive can use the optimum field weakening range provided that an electric drive is selected for the differential drive.

In the high wind/output range, as FIG. 12 shows, the 4-pole three-phase a.c. machine 8 is connected to the network, and the differential drive 6 is connected to the 6-pole three-phase a.c. machine 16 via the frequency converter 7. As a result, the slip power of the differential drive of the common shaft of the three-phase a.c. machines 8 and 16 that is necessary in motor operation is removed, and the differential drive 6 is supplied via a three-phase a.c. machine 16 and a frequency converter 7. In generator operation, the power flow is implemented in the reverse direction.

As a result, the frequency converter 7 in no case feeds into the network, hence the IGBT converter can be replaced by, e.g., a so-called thyristor converter, which is significantly more economical and sturdier than the IGBT converter but had a significantly poorer power delivery quality with respect to network behavior.

In the embodiment of the invention, in which a single pole-switching machine is used instead of the two separate generators 8, 16, the frequency converter 7 can be connected to one of the two windings, preferably the winding with the higher number of pole pairs.

The above-described embodiments can also be implemented in technically similar applications. This primarily relates to hydro-electric power plants for exploiting river and ocean currents. For this application, the same basic requirements apply as for wind power plants, namely variable flow speed.

1. Power plant, in particular a wind power plant, with a drive shaft, a generator (8), and with a differential gear (11 to 13) with three drives and power take-offs, whereby a first drive is connected to the drive shaft, a power take-off is connected to a generator (8), and a second drive is connected to a differential drive (6), characterized in that two generators (8, 16) are provided with a different number of pole pairs, which can be connected to the power take-off.

2. Power plant according to claim 1, wherein the two generators (8, 16) are connected permanently to the drive.

3. Power plant according to claim 1, wherein the differential drive (6) is connected to the network and/or to one of the two generators (8, 16).

4. Power plant according to claim 3, wherein the differential drive (6) can be connected to the generator (16) with the higher number of pole pairs.

5. Power plant according to claim 1, wherein the differential drive (6) is connected permanently to the network, and wherein, alternately, one of the two generators (8, 16) is connected to the network.

6. Power plant according to claim 1, wherein the differential drive (6) is connected via a frequency converter (7) to the network and/or to one of the two generators (8, 16).

7. Power plant, in particular a wind power plant, with a drive shaft, a generator (8), and with a differential gear (11 to 13) with three drives and power take-offs, whereby a first drive is connected to the drive shaft, a power take-off is connected to a generator (8), and a second drive is connected to a differential drive (6), wherein the generator (8) is pole-switching.

8. Power plant according to claim 7, wherein the stator windings of the generator (8) are made separately.

9. Power plant according to claim 8, wherein the differential drive (6) is connected to the network and/or to one of the two stator windings.

10. Power plant according to claim 9, wherein the differential drive (6) can be connected to the stator winding with the higher number of pole pairs.

11. Power plant according to claim 8, wherein the differential drive (6) is connected permanently to the network, and wherein, alternately, one of the two stator windings is connected to the network.

12. Power plant according to claim 1, wherein the differential drive (6) is connected to the network and/or to a generator (8, 16) via a frequency converter (7).

13. Power plant according to claim 1, wherein the generator(s) (8, 16) are remotely activated synchronous generators.

14. Power plant according to claim 3, wherein the differential drive (6) is a three-phase a.c. machine.

15. Power plant according to claim 14, wherein the differential drive (6) is a permanent-magnet-activated synchronous three-phase a.c. machine.

16. Power plant according to claim 1, wherein the differential drive is a hydraulic drive.

17. Power plant according to claim 1, wherein it has a one-stage differential gear (3).

18. Power plant according to claim 1, wherein it has a multi-stage differential gear (3, 4).

19. Power plant according to claim 1, wherein the drive shaft is the rotor shaft of a wind power plant.

20. Power plant according to claim 1, wherein the first drive that is connected to the drive shaft rotates at a basic speed and wherein the speed range of the first drive is at least −/+6.0% and at most −/+20.0% of the basic speed, while the differential drive (6) is operated at nominal speed.

21. Method for operating a power plant, in particular a wind power plant, with three drives and power take-offs, whereby a first drive is connected to a drive shaft of the power plant, a power take-off is connected to a generator (8), and a second drive is connected to a differential drive (6), wherein two generators (8, 16) are alternately connected to the network with a different number of pole pairs.

22. Method according to claim 21, wherein the output of the generator that is connected to the network is set to zero, wherein this generator is then separated from the network, and wherein subsequently the other generator is synchronized with the network and then is connected to the network.

23. Method for operating a power plant, in particular a wind power plant, with three drives and power take-offs, whereby a first drive is connected to a drive shaft of the power plant, a power take-off is connected to a generator (8), and a second drive is connected to a differential drive (6), wherein the windings of a pole-switching generator (8) are connected alternately to the network.

24. Method according to claim 21, wherein the output of the generator (8) is set to zero, wherein the winding of the generator (8) that is connected to the network is then separated from the network, and wherein then the other winding of the generator (8) is synchronized with the network and then connected to the network.
